(19) United States
(12) Patent Application Publication
(10) Pub. No.: US 2007/0063865 A1
(43) Pub. Date: Mar. 22, 2007

(54) Wellbore telemetry system and method

(75) Inventors: Raghu Madhavan, Houston, TX (US); David Santoso, Sugar Land, TX (US); Kanu Chadha, San Diego, CA (US); Lise B. Hvatum, Katy, TX (US)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation

(21) Appl. No.: 11/228,111

(22) Filed: Sep. 16, 2005

(51) Int. Cl. G01V 3/00

(52) U.S. Cl. 340/853.1

(57) ABSTRACT

A telemetry kit for passing signals between a surface control unit and a downhole tool via a wired drill pipe telemetry system is provided. The kit has a first terminal operatively connectable to the wired drill pipe telemetry system for communication therewith, a second terminal operatively connectable to one of the surface control unit and the downhole tool for communication therewith and at least one transmission element operatively connecting the first terminal to the second terminal. The telemetry kit is positionable such that the telemetry kit traverses at least a portion of the downhole tool and/or the wired drill pipe telemetry system whereby the signals bypass the portion thereof.

### BACKGROUND OF INVENTION

1. Field of the Invention

The present invention relates to telemetry systems for use in wellbore operations. More particularly, the present invention relates to telemetry systems for providing power to downhole operations and/or for passing signals between a surface control unit and a downhole tool positionable in a wellbore penetrating a subterranean formation.

2. Background Art

The harvesting of hydrocarbons from a subterranean formation involves the deployment of a drilling tool into the earth. The drilling tool is driven into the earth from a drilling rig to create a wellbore through which hydrocarbons are passed. During the drilling process, it is desirable to collect information about the drilling operation and the underground formations. Sensors are provided in various portions of the surface and/or downhole systems to generate data about the wellbore, the earth formations, and the operating conditions, among others. The data is collected and analyzed so that decisions may be made concerning the drilling operation and the earth formations.

Telemetry systems are utilized in the analysis and control of wellbore operations and allow for analysis and control from a surface control station that may be located on site, or may be remote. The information gathered allows for more effective control of the drilling system and further provides useful information for analysis of formation properties and other factors affecting drilling. Additionally, the information may be used to determine a desired drilling path, optimum conditions or otherwise benefit the drilling process.

Various telemetry tools allow for the measuring and logging of various data and transmission of such data to a surface control system. Measurement while drilling (MWD) and logging while drilling (LWD) components may be disposed in a drillstring to collect desired information. Various approaches have been utilized to pass data and/or power signals from the surface to the measurement and logging components disposed in the drillstring. These may include, for example, mud-pulse telemetry as described in U.S. Pat. No. 5,517,464, wired drill pipe as described in U.S. Pat. No. 6,641,434, and others.

Despite the development and advancement of telemetry devices in wellbore operations, there remains a need to provide additional reliability and telemetry capabilities. Like any other wellbore device, telemetry devices sometimes fail. Additionally, the power provided by telemetry devices may be insufficient to power desired wellbore operations. Moreover, it is often difficult to extend communication links through certain downhole tools, such as drilling jars. Furthermore, the couplings used in power and/or data transmission lines in a drillstring are often exposed to a harsh environment including variations and extremes of pressure and temperature, contributing to the failure rate of such transmission systems.

Accordingly, there remains a need to provide telemetry systems capable of extending across portions of the telemetry devices and/or downhole tool. In some cases, it is desirable to provide redundancy to the existing telemetry system and/or to bypass portions of existing systems. It is further desirable that such a system provide simple and reliable operation and be compatible with a variety of tools and bottom hole assemblies (BHAs). Such techniques preferably provide one or more of the following among others increased speed, increased reliability, increased power capabilities and diagnostic capabilities.

### SUMMARY OF INVENTION

A telemetry kit for passing signals between a surface control unit and a downhole tool via a wired drill pipe telemetry system is provided. The kit has a first terminal operatively connectable to the wired drill pipe telemetry system for communication therewith, a second terminal operatively connectable to the surface control unit and/or the downhole tool for communication therewith and at least one transmission element operatively connecting the first terminal to the second terminal. The telemetry kit is positionable such that the telemetry kit traverses at least a portion of the downhole tool and/or the wired drill pipe telemetry system whereby the signals bypass the portion thereof.

In another aspect, the invention relates to a communication system for a wellsite having a surface control unit and a downhole tool. The downhole tool is deployed via a drill string into a wellbore penetrating a subterranean formation. The system has at least one wired drill pipe telemetry system disposed in at least a portion of the drillstring and at least one telemetry kit. The wired drill pipe telemetry system is adapted to pass signals between the surface control unit and the downhole tool. The telemetry kit has a first terminal operatively connectable to the wired drill pipe telemetry system for communication therewith, a second terminal operatively connectable to the surface control unit or the downhole tool for communication therewith and at least one transmission element operatively connecting the first terminal to the second terminal. The telemetry kit is positionable such that the telemetry kit traverses at least a portion of one of the downhole tool, the wired drill pipe telemetry system and combinations thereof whereby the signals bypass the at least the portion thereof.

In another aspect, the invention relates to a method of communicating between a surface control unit and a downhole tool via a wired drill pipe telemetry system. The downhole tool deployed via a drill string into a wellbore penetrating a subsurface formation. The method involves operatively connecting a first terminal of a telemetry kit to the wired drill pipe telemetry system for communication therewith, operatively connecting a second terminal of the telemetry kit to a downhole tool or a surface control unit for communication therewith and operatively connecting a transmission element between the first and second terminals such that the telemetry kit traverses at least a portion of the downhole tool and/or the wired drill pipe telemetry system and passing a signal between the surface control unit and the downhole tool via the. wired drill pipe and the telemetry kit.

Other aspects and advantages of the invention will be apparent from the following description and the appended claims.

### BRIEF DESCRIPTION OF DRAWINGS

So that the above recited features and advantages of examples of the present invention may be more clearly understood, certain examples are illustrated in the appended drawings. The appended drawings illustrate only typical examples of the invention and are therefore not to be considered limiting of its scope, for the invention may admit to additional effective examples.

FIG. 1 is a schematic diagram of a wellsite system having a downhole tool deployed from a rig via a drill string, the wellsite provided with a wellbore communication system having a surface telemetry sub and a wired drill pipe telemetry system.

FIG. 2 shows a prior art portion of the wired drill pipe telemetry system of FIG. 1 depicting a plurality of wired drill pipes.

FIG. 3A shows a portion of the wellbore communication system of FIG. 1 depicting a surface telemetry sub.

FIG. 3B shows an alternate version of the surface telemetry sub of FIG. 3A.

FIG. 4 shows a telemetry kit usable as part of the wellbore communication system of FIG. 1.

FIG. 5A shows a portion of the wellbore communication system of FIG. 1 provided with a first telemetry kit positioned in a portion of the downhole tool and a second telemetry kit positioned in a portion of the drill string.

FIG. 5B shows a portion of the wellbore communication system of FIG. 1 having a telemetry kit extending across a portion of the downhole tool and the drill string.

FIG. 6A shows the wellbore communication system having a telemetry kit positioned between the wired drill pipe telemetry system and the downhole tool.

FIG. 6B shows the wellbore communication system having a telemetry kit positioned between the wired drill pipe telemetry system and the surface telemetry sub.

### DETAILED DESCRIPTION

Presently preferred examples of the invention are shown in the above-identified figures and described in detail below. In describing the preferred examples, like or identical reference numerals are used to identify common or similar elements. The figures are not necessarily to scale and certain features and certain views of the figures may be shown exaggerated in scale or in schematic in the interest of clarity and conciseness.

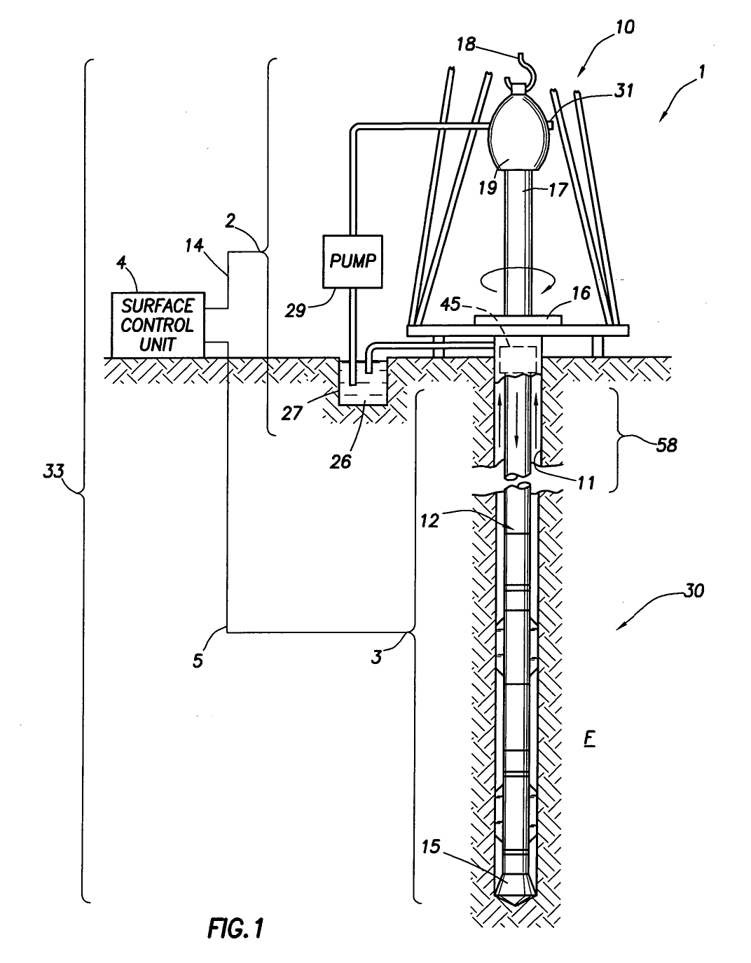

FIG. 1 illustrates an example of a wellsite system 1 with which the present invention can be utilized to advantage. The wellsite system 1 includes a surface system 2, a downhole system 3 and a surface control unit 4. A borehole 11 is formed by rotary drilling. Those of ordinary skill in the art given the benefit of this disclosure will appreciate, however, that the present invention also may be utilized in drilling applications other than conventional rotary drilling (e.g., mud-motor based directional drilling), and their use is not limited to land-based rigs. Also, variations on the type of drilling system may be used, such as top drive, kelly or other systems.

The downhole system 3 includes a drillstring 12 suspended within the borehole 11 with a drill bit 15 at its lower end. The surface system 2 includes a land-based platform and derrick assembly 10 positioned over the borehole 11 penetrating a subsurface formation F. The drillstring 12 is rotated by a rotary table 16, which engages a kelly 17 at the upper end of the drillstring 12. The drillstring 12 is suspended from a hook 18, attached to a traveling block (not shown), through the kelly 17 and a rotary swivel 19 which permits rotation of the drillstring relative to the hook 18.

The surface system further includes drilling fluid or mud 26 stored in a pit 27 formed at the wellsite. A pump 29 delivers the drilling fluid 26 to the interior of the drillstring 12 via a port in the swivel 19, inducing the drilling fluid 26 to flow downwardly through the drillstring 12. The drilling fluid 26 exits the drillstring 12 via ports in the drill bit 15, and then circulates upwardly through the region between the outside of the drillstring and the wall of the borehole, called the annulus. In this manner, the drilling fluid 26 lubricates the drill bit 15 and carries formation cuttings up to the surface as it is returned to the pit 27 for recirculation.

The drillstring 12 further includes a downhole tool or bottom hole assembly (BHA), generally referred to as 30, near the drill bit 15. The BHA 30 includes components with capabilities for measuring, processing, and storing information, as well as communicating with the surface. The BHA 30 thus may include, among other things, at least one measurement tool, such as a logging-while-drilling tool (LWD) and/or measurement while drilling tool (MWD) for determining and communicating one or more properties of the formation F surrounding borehole 11, such as formation resistivity (or conductivity), natural radiation, density (gamma ray or neutron), pore pressure, and others. The MWD may be configured to generate and/or otherwise provide electrical power for various downhole systems and may also include various measurement and transmission components. Measurement tools may also be disposed at other locations along the drillstring 12.

The measurement tools may also include a communication component, such as a mud pulse telemetry tool or system, for communicating with the surface system 2. The communication component is adapted to send signals to and receive signals from the surface. The communication component may include, for example, a transmitter that generates a signal, such as an electric, acoustic or electromagnetic signal, which is representative of the measured drilling parameters. The generated signal is received at the surface by a transducer or similar apparatus, represented by reference numeral 31, a component of the surface communications link (represented generally at 14), that converts a received signal to a desired electronic signal for further processing, storage, encryption, transmission and use. It will be appreciated by one of skill in the art that a variety of telemetry systems may be employed, such as wired drill pipe, electromagnetic or other known telemetry systems.

A communication link may be established between the surface control unit 4 and the downhole system 3 to manipulate the drilling operation and/or gather information from sensors located in the drillstring 12. In one example, the downhole system 3 communicates with the surface control unit 4 via the surface system 2. Signals are typically transmitted to the surface system 2, and then transferred from the surface system 2 to the surface control unit 4 via surface communication link 14. Alternatively, the signals may be passed directly from a downhole drilling tool to the surface control unit 4 via communication link 5 using electromagnetic telemetry (not shown) if provided. Additional telemetry systems, such as mud pulse, acoustic, electromagnetic, seismic and other known telemetry systems may also be incorporated into the downhole system 3.

The surface control unit 4 may send commands back to the downhole system 3 (through e.g., communication link 5 or surface communication link 14) to activate and/or control one or more components of the BHA 30 or other tool located in the drillstring 12, and perform various downhole operations and/or adjustments. In this fashion, the surface control unit 4 may then manipulate the surface system 2 and/or downhole system 3. Manipulation of the drilling operation may be accomplished manually or automatically.

As shown in FIG. 1, the wellsite system 1 is provided with a wellbore communication system 33. The wellbore communication system 33 includes a plurality of wired drill pipes (WDPs) linked together to form a WDP telemetry system 58, to transmit a signal through the drillstring 12. Alternatively, the WDP telemetry system may be a wireless system extending through a plurality of drill pipe using a conductive signal. Signals are typically passed from the BHA 30 via the wired drill pipe telemetry system 58 to a surface telemetry sub 45. As shown, the surface telemetry sub 45 is positioned at the uphole end of the WDP telemetry system 58. However, in some cases, the surface telemetry sub 45 may be positioned above or adjacent to the kelly 17. The signals referred to herein may be communication and/or power signals.

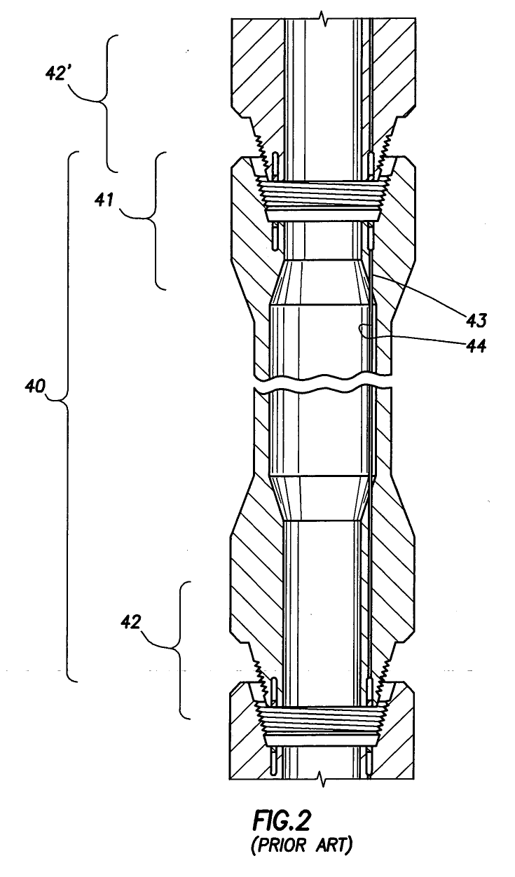

FIG. 2 shows a detailed portion of an optional WDP telemetry system usable as the WDP telemetry system of FIG. 1. The WDP telemetry system may be a system such as the one described in U.S. Pat. No. 6,641,434, the entire contents of which are hereby incorporated by reference. As shown in FIG. 2, a WDP 40 will typically include a first coupling element 41 at one end and a second coupling element 42 at a second end. The coupling elements 41, 42 are configured to transmit a signal across the interface between two adjacent components of the drillstring 12, such as two lengths of WDP 40. Transmission of the signal across the interface may utilize any means known in the art, including but not limited to, inductive, conductive, optical, wired or wireless transmission.

WDP 40 will typically include an internal conduit 43 enclosing an internal electric cable 44. Accordingly, a plurality of operatively connected lengths of WDP 40 may be utilized in a drillstring 12 to transmit a signal along any desired length of the drillstring 12. In such fashion a signal may be passed between the surface control unit 4 of the wellsite system 1 and one or more tools disposed in the borehole 11, including MWDs and LWDs.

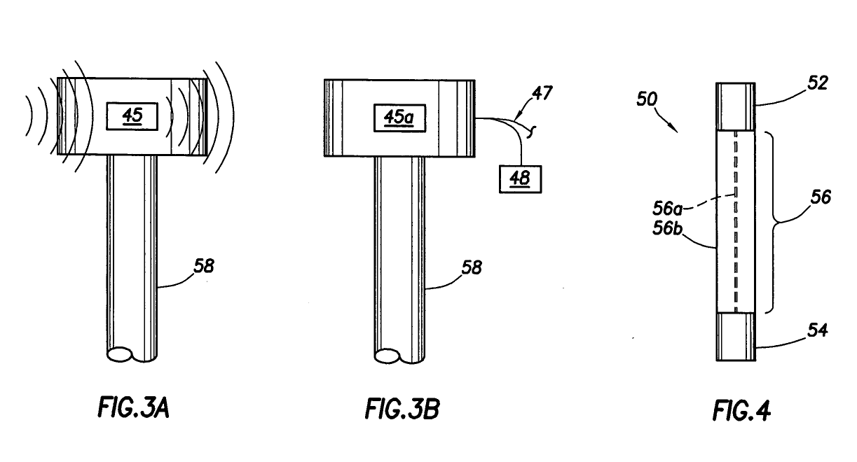

FIG. 3A shows the surface telemetry sub 45 of FIG. 1 in greater detail. The surface telemetry sub 45 is operatively connected to the WDP telemetry system 58 for communication therewith. The surface telemetry sub 45 may then operatively connect to the surface control unit 4 (FIG. 1). The surface telemetry sub 45 may be located at or near the top of the drillstring 12, and may include a transmitter and/or receiver (such as transmitter/receiver 48 of FIG. 3B) for exchanging signals with the surface control unit 4, and/or one or more components of the surface system 2 in communication with one or more surface control unit 4. As shown, the surface sub 45 can wirelessly communicate with the surface unit.

Alternatively, as shown in FIG. 3B, the surface telemetry sub 45a of the wellsite system 1 may comprise slip rings and/or a rotary transformer that may be operatively connected to the surface control unit 4 (FIG. 1) by means of a cable 47, a transmitter/receiver 48, a combination thereof, and/or any other means known in the art. Depending on configuration and other factors, the surface telemetry sub 45a may be disposed in an upper portion of the downhole system 3, in the surface system 2 of the wellsite system 1, or in an interface therebetween. The surface telemetry sub operatively connects the WDP telemetry system 58 and the surface control unit 4 (FIG. 1).

Either configuration of the surface telemetry sub (45, 45a) may be provided with wireless and/or hardwired transmission capabilities for communication with the surface control unit 4. Configurations may also include hardware and/or software for WDP diagnostics, memory, sensors, and/or a power generator.

Referring now to FIG. 4, an example of a telemetry kit 50 is depicted. The telemetry kit includes a terminal 52 and a terminal 54 for operatively connecting a transmission element (generally represented at 56) for the transmission of a signal therebetween. Either or both of the terminals 52, 54 may comprise a sub, or alternatively may comprise a configuration of one or more components of a drillstring (e.g., a collar, drill pipe, sub, or tool) such that the component will operatively connect to the transmission element 56.

The operative connection between transmission element 56 and terminal 52, 54 may be reversible. For example, terminal 52 may be at an uphole end and terminal 54 at a downhole end as shown. Alternatively, where end connectors are provided to establish connections to adjacent devices, the terminals may be switched such that terminal 54 is at an uphole end and terminal 52 is at a downhole end. A reversible connection advantageously facilitates the disposition of the transmission element 56 in the drillstring 12 during or after make-up of a particular section of the drillstring 12.

Transmission through and/or by a telemetry kit 50 may be inductive, conductive, optical, wired or wireless. The mode of transmission is not intended to be a limitation on the telemetry kit 50 and therefore the examples described herein, unless otherwise indicated, may be utilized with any mode of transmission.

As shown, the kit preferably includes a cable 56a extending between the terminals. However, in some cases, a cable may not be required. For example, in some cases, a specialized pipe 56b may be used. A specialized pipe, such as conductive pipe, may be used to pass signals between the terminals. In some cases, it may be possible to have wireless transmission between the terminals. Other apparatuses, such as electromagnetic communication systems capable of passing signals through the formation and/or kit, can be used for transmitting a signal between terminals 52, 54.

When a cable 56a is used as a transmission element 56, the cable may be of any type known in the art, including but not limited to wireline heptacable, coax cable, and mono cable. The cable may also include one or more conductors, and/or one or more optical fibers (e.g., single mode, multi mode, or any other optical fiber known in the art). Cables may be used to advantageously bypass stabilizers, jars and heavy weights disposed in the BHA 30. It is also advantageous to have a cable that is able to withstand the drilling environment, and one that may support a field termination for fishing and removal of the cable.

The terminals 52, 54 may be configured to conduct signals through an operative connection with adjoining components. The terminal 54 may be used to operatively connect to the downhole tool or BHA. An interface may be provided for operative connection therewith. The terminals may interface, directly or through one or more additional components, with a downhole telemetry sub (not shown in FIG. 4) disposed downhole. The terminal 52 may be configured to operatively connect to a WDP telemetry system 58.

In one example, the terminal(s) may be configured to support the weight of various other components of the telemetry kit 50 through e.g., a fishing neck, and may include an electrical and/or mechanical mechanism when utilized with cable to support and connect to the cable, while permitting transmission therethrough. The terminal(s) may also include an interface for operatively connecting to the WDP telemetry system 58 (FIG. 1). It may also be desirable to dispose other devices, such as a cable modems, one or more sensors, clocks, processor, memories, diagnostics, power generators and/or other devices capable of downhole operations, in the terminal(s) and/or kit.

The terminal(s), for example when used with cable as the transmission element 56, may include a latch for reversibly locking the end of the cable and will also be configured to pass a signal. The reversible locking mechanism of the latch may be of any type known in the art, and may be configured to release upon sufficient tensile pull of the cable.

When cable is not used as a transmission element 56, it may be desirable to include a through-bore configuration in the terminal 54, to allow for fishing of downhole components. A cable modem, one or more sensors, memory, diagnostics, and/or a power generator may also be disposed in the second terminal 54.

The telemetry kit 50 may be configured to include one or more standard lengths of drill pipe and/or transmission element 56. The length of the kit may be variable. Variations in length may be achieved by cutting or winding that portion of the transmission element 56 that exceeds the distance required to operatively connect the terminals 52, 54, or by extending across various numbers of drill pipes. In one configuration where the transmission element 56 comprises a cable, one or more of the terminals 52, 54 may include a spool or similar configuration for the winding of excess cable.

The spool or similar configuration may be biased to exert and/or maintain a desired pressure on the cable, advantageously protecting the cable from damage due to variations in the distance between the terminals 52, 54. Such configurations further advantageously allow for the use of suboptimal lengths of cable for a particular transmission length, and for the use of standardized lengths of cable to traverse varying distances. When utilized with cable or other non-pipe transmission elements 56a, one or more drill pipes may also be disposed between the terminals 52, 54 of the telemetry kit 50. This drill pipe may be used to protect the transmission element 56 disposed therebetween and/or house components therein.

The telemetry kit 50 may be disposed to traverse at least a portion of the WDP telemetry system. By traversing a portion of the WDP system, at least a portion of the WDP system may be eliminated and replaced with the telemetry kit. In some cases, the kit overlaps with existing WDP system to provide redundancy. This redundancy may be used for added assurance of communication and/or for diagnostic purposes. For example, such a configuration may also advantageously provide a system for diagnosing a length of WDP by providing an alternative system for signal transmission such that signals transmitted through telemetry kit 50 may be compared to those transmitted through an overlapping portion of the WDP telemetry system. Differences between the signal transmitted through the telemetry kit 50 and those transmitted through the overlapping portion of the WDP telemetry system may be used to identify and/or locate transmission flaws in one or more WDPs. Furthermore, such differences may also be used to identify and/or locate transmission flaws in the telemetry kit 50.

The telemetry kit 50 may extend across one or more drill pipes in various portions of the drill string 12 and/or downhole tool. Various components, tools or devices may be positioned in one or more of these drill pipes. In this way, the telemetry kit 50 may overlap with portions of the BHA and/or drill string and contain various components used for measurement, telemetry, power or other downhole functions.

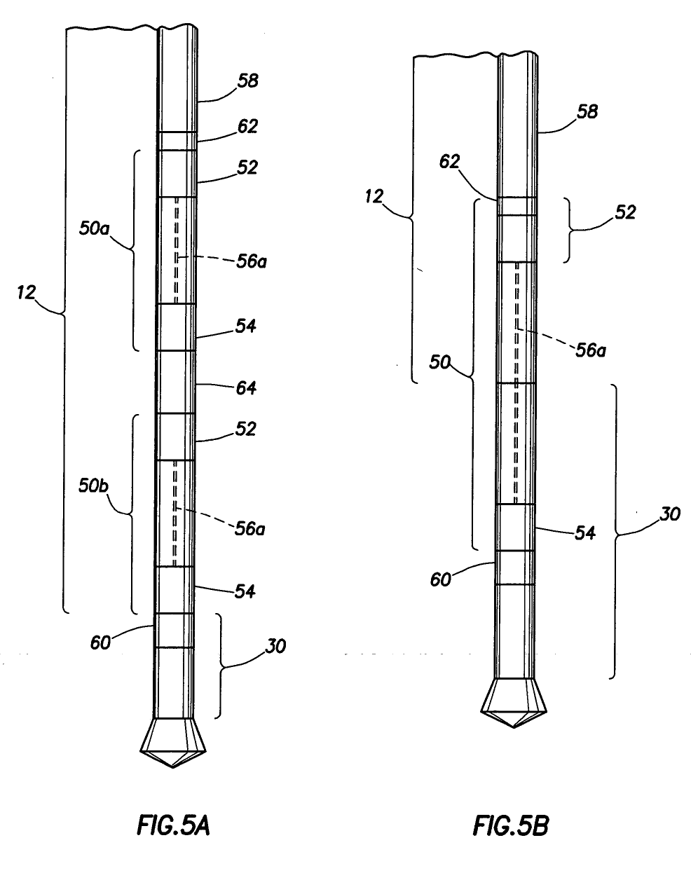

FIGS. 5A and 5B depict one or more telemetry kits 50 positioned about various portions of the wired drill pipe telemetry system 58 and the downhole tool to pass signals therebetween. In the example shown, these kits are provided with cables 56a. The telemetry kits 50 may be located in the drillstring 12 and/or an upper portion of the BHA 30. FIG. 5A schematically depicts a downhole portion of the wellbore communication system 33 of FIG. 1. As shown in FIG. 5A, the WDP telemetry system 58 is operatively connected to the BHA 30 via two telemetry kits 50a, 50b. The telemetry kits 50a, 50b are disposed below the WDP 58.

The telemetry kits may be operatively connected to the WDP telemetry system 58 and/or the BHA 30 via a variety of operative connections. As shown, the operative connection may be a telemetry sub 60, a telemetry adapter 62 and/or additional drill pipes 64 having a communication link for passing signals from the kit(s) to the WDP telemetry system and/or the downhole tool. The telemetry sub 60 is adapted for connection with various components in the BHA 30 for communication therewith. The telemetry sub 60 may be provided with a processor for analyzing signals passing therethrough.

The additional drill pipes 64 are provided with communication devices and processors for analyzing signals and communicating with the kits. The telemetry adapter 62 is adapted for connection to the WDP telemetry system 58 for communication therewith. The various operative connections may function to, among other things, interface between WDP telemetry system 58, BHA 30 and other components to enable communication therebetween. The operative connections may include WDP and/or non-WDP diagnostics, sensors, clocks, processors, memory, and/or a power generator. Optionally, the operative connections 62, 64 and 60 can be adapted for connection to one or more types of WDP telemetry systems.

A terminal 52 of an upper telemetry kit 50a is operatively connected to the WDP telemetry system 58 via telemetry adapter 62. The WDP telemetry system and/or the kit may include one or more repeater subs (not shown) for amplifying, reshaping, and/or modulating/demodulating a signal transmitted through the telemetry kit 50 and WDP telemetry system 58.

In the example of FIG. 5A, two telemetry kits 50a, 50b are shown. Where a plurality of telemetry kits 50 are used, additional drill pipe(s) 64, containing tools such as measurement tools and/or sensor subs 64, may be disposed between the telemetry kits 50. A lower terminal 54 of the lower telemetry kit 50b is operatively connected to a downhole telemetry sub 60 of the downhole tool. The downhole telemetry sub 60 is one component of the operative connection between telemetry kit 50 and one or more tools located in the BHA 30. Communications between a downhole telemetry sub 60 and such tools may utilize a standardized language between the tools, such as a signal protocol, or may have different languages with an adapter therebetween for translation. As shown in FIG. 5A, the downhole telemetry sub 60 may be positioned in the BHA 30 such that the lower telemetry kit 50b traverses an upper portion of the BHA 30. Alternatively, the downhole telemetry sub 60 may be located between the drill string 12 and BHA 30 such that the operatively connected lower telemetry kit 50b is disposed above the BHA 30, in the drillstring 12.

The tools to which the downhole telemetry sub 60 may operatively connect may include one or more LWDs, MWDs, rotary steerable systems (RSS), motors, stabilizers and/or other downhole tools typically located in the BHA 30. By bypassing one or more such components, it eliminates the need to establish a communication link through such components. In some cases, the ability to bypass certain components, such as drilling jars, stabilizers and other heavy weight drill pipes, certain costs may be reduced and performance enhanced.

As shown in FIG. 5B, a telemetry kit 50 may extend through a portion of drillstring 12, below a portion of the WDP telemetry system 58 and into an upper portion of the BHA 30. By bypassing the upper portion of the BHA 30, the telemetry kit 50 is intended to traverse the portion of the drillstring 12 occupied by such components.

As shown in FIG. 5B, one or more of the operative connections may be incorporated into the kit 50. The telemetry adapter 62 is functionally positioned within the telemetry kit 50 to provide the communication connection with the WDP system 58. Similarly, while telemetry sub 60 is shown as a separate item from the telemetry kit, the telemetry sub 60 could be integral with the kit.

A downhole telemetry sub 60 is disposed in the BHA 30 and is operatively connected to one or more components (not shown) disposed in the lower portion of the BHA 30 (e.g., LWDs, MWDs, rotary steerable systems, motors, and/or stabilizers). Optionally, the downhole telemetry sub 60 may be located above or in between various tools, such as the LWD/MWD tools of the BHA 30, and operatively connected to the kit 50 and the tools of the BHA 30. As previously discussed, the downhole telemetry sub 60 operatively connects to terminal 54 of the telemetry kit 50, and may be integrated with the terminal 54 of the telemetry kit 50.

While FIGS. 5A and 5B depict specific configurations for placement of a telemetry kit 50 in a wellbore communication system, it will be appreciated that one or more telemetry kits 50 may be positioned in one or more drill collars. The telemetry kit(s) 50 may extend through a portion of the drill string 12 and/or a portion of the downhole tool. The telemetry kit 50 is preferably positioned to provide a communication link between the wired drill pipe telemetry system 58 and the downhole components. In this manner, the telemetry kit 50 may bypass devices that may impede communications and/or provide an efficient link between portions of the drill string 12 and/or downhole tool.

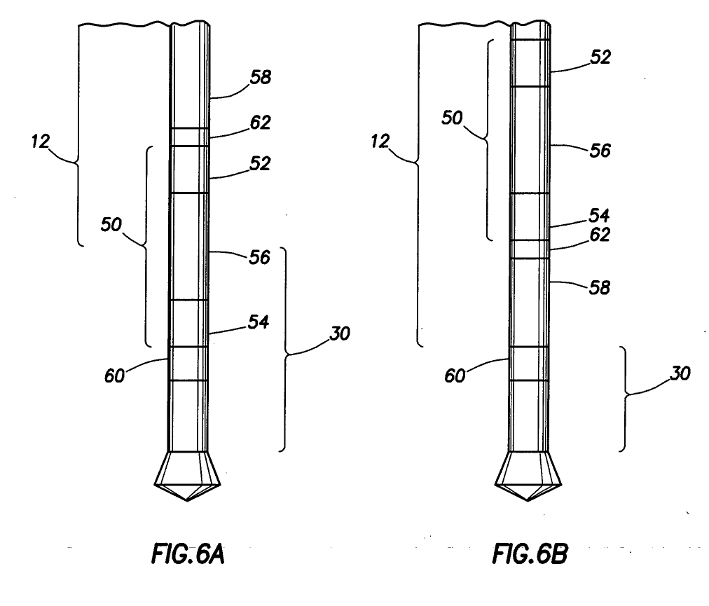

Referring now to FIGS. 6A and 6B, additional configurations depicting a telemetry kit 50 are provided. In the examples shown in FIGS. 6A and 6B, the telemetry kit does not require a wire 56a. This telemetry kit 50 has a specialized pipe 56b in place of the wired transmission element 56a (e.g., cable) of the telemetry kit 50 used in FIGS. 5A and 5B. This specialized drill pipe may be, for example, a conductive drill pipe having a metal portion extending between the terminals. The metal portion adapted to pass a signal between the terminals. Examples of such techniques for passing signals between terminals using metal piping are disclosed in U.S. Pat. Nos. 4,953,636 and 4,095,865. At least one telemetry kit 50 is operatively connected to a WDP telemetry system 58 of drillstring 12 such that a signal may be passed between the surface telemetry sub (45 in FIG. 1) and the BHA 30.

As shown in FIG. 6A, the telemetry kit 50 is positioned between the WDP telemetry system 58 and the BHA 30. A telemetry adapter 62 operatively connects the WDP telemetry system 58 to terminal 52 of the telemetry kit 50. A downhole telemetry sub 60 connects to or is integral with a downhole terminal 54 of the telemetry kit 50. The downhole telemetry sub 60 forms an operative connection between the telemetry kit 50 and one or more components of the BHA 30.

As previously described, the telemetry kit 50 may be disposed such that it traverses an upper portion of the BHA 30, and operatively connects to one or more tools disposed in the lower portion of the BHA 30. Signals passed through examples utilizing specialized drill pipe as a transmission element 56 will typically pass conductively, however, the terminals 52, 54 may be configured to pass the signal to adjacent components of the drillstring 12.

The example shown in FIG. 6A depicts a kit traversing a portion of the BHA 30. However, the kit may traverse at least a portion of the WDP telemetry system and/or the BHA as desired.

Referring now to FIG. 6B, the telemetry kit 50 is located above the WDP telemetry system 58. Downhole terminal 54 of the telemetry kit 50 is operatively connected to WDP 58 via telemetry adapter 62. At its upper end, an uphole terminal 52 of the telemetry kit 50 operatively connects to the surface telemetry sub (45 in FIG. 1). An additional telemetry adapter may be positioned between the kit and the surface telemetry sub and the kit for passing a signal therebetween. The surface telemetry sub 45 may be integral with the upper terminal 52 of the telemetry kit 50 and/or the telemetry adapter. At its downhole end, the WDP telemetry system 58 is operatively connected to the BHA 30 by means of a telemetry sub 60, as previously described.

It may be desirable in various configurations to configure the subs and/or telemetry adapters of the downhole system to include one or more transmitters and/or sensors in order to maintain one or two-way communications with a surface control unit 4. In various configurations, it may be desirable to operatively connect a subs 45, 60 and/or telemetry adapter 62 to one or both ends of a telemetry kit, WDP telemetry system 58, or specialized (e.g., conductive) pipe. One or more of the various operative connectors may be integral with or separate from portions of the kit, such as an adjacent terminal, and/or portions of the WDP telemetry system and/or BHA. Various combinations of the various kits with one or more WDP telemetry systems, BHAs and/or operative connections may be contemplated. For example, a kit with a cable maybe positioned uphole from the WDP telemetry system as shown in FIG. 6B.

Unless otherwise specified, the telemetry kit, WDP, telemetry subs, telemetry adapters, and/or other components described in various examples herein may be disposed at any location in the drillstring, and with respect to each other. Furthermore, it may be advantageous to combine telemetry kits 50 with or without cables 56a within the same wellsite system 1. The particular configurations and arrangements described are not intended to be comprehensive, but only representative of a limited number of configurations embodying the technologies described. While the invention has been described with respect to a limited number of examples, those skilled in the art, having benefit of this disclosure, will appreciate that other examples can be devised which do not depart from the scope of the invention as disclosed herein. Accordingly, the scope of the invention should be limited only by the attached claims.

What is claimed is:

1. A telemetry kit for passing signals between a surface control unit and a downhole tool via a wired drill pipe telemetry system, the downhole tool deployed via a drill string into a wellbore penetrating a subterranean formation, comprising:
a first terminal operatively connectable to the wired drill pipe telemetry system for communication therewith;
a second terminal operatively connectable to one of the surface control unit and the downhole tool for communication therewith; and
at least one transmission element operatively connecting the first terminal to the second terminal;
wherein the telemetry kit is positionable such that the telemetry kit traverses at least a portion of one of the downhole tool, the wired drill pipe telemetry system and combinations thereof whereby the signals bypass the at least the portion thereof.

2. The telemetry kit of claim 1, wherein the second terminal is operatively connectable to the surface control unit via a surface sub.

3. The telemetry kit of claim 2, wherein the at least one transmission element is extendable through at least a portion of the wired drill pipe telemetry system.

4. The telemetry kit of claim 1, wherein the second terminal is operatively connectable to the downhole tool.

5. The telemetry kit of claim 4, wherein the at least one transmission element is extendable through at least a portion of the wired drill pipe telemetry system.

6. The telemetry kit of claim 4, wherein the at least one transmission element is extendable through at least a portion of the downhole tool.

7. The telemetry kit of claim 4, wherein the at least one transmission element is extendable through at least a portion of the downhole tool and at least a portion of the wired drill pipe telemetry system.

8. The telemetry kit of claim 4, wherein the second terminal is operatively connectable to the downhole tool via a telemetry sub.

9. The telemetry kit of claim 1 wherein the first terminal is operatively connectable to the wired drill pipe telemetry system via a telemetry adapter.

10. The telemetry kit of claim 1, wherein a transmission mode of the telemetry kit is at least one selected from conductive, inductive, and optical.

11. The telemetry kit of claim 1, wherein the transmission element comprises a cable.

12. The telemetry kit of claim 1, wherein the transmission element comprises at least one conductive drill pipe, the conductive drill pipe forming at least a portion of one of the drill string, the downhole tool and combinations thereof.

13. The telemetry kit of claim 1, wherein the telemetry kit traverses an upper portion of the downhole tool.

14. The telemetry kit of claim 13, wherein the second terminal operatively connects to at least one component located in a lower portion of the downhole tool.

15. A communication system for a wellsite having a surface control unit and a downhole tool, the downhole tool deployed via a drill string into a wellbore penetrating a subterranean formation, comprising:
at least one wired drill pipe telemetry system disposed in at least a portion of the drillstring, the at least one wired drill pipe telemetry system adapted to pass signals between the surface control unit and the downhole tool; and
at least one telemetry kit comprising:
a first terminal operatively connectable to the wired drill pipe telemetry system for communication therewith;
a second terminal operatively connectable to one of the surface control unit and the downhole tool for communication therewith; and
at least one transmission element operatively connecting the first terminal to the second terminal;
wherein the telemetry kit is positionable such that the telemetry kit traverses at least a portion of one of the downhole tool, the wired drill pipe telemetry system and combinations thereof whereby the signals bypass the at least the portion thereof.

16. The wellbore communication system of claim 15, further comprising at least one telemetry sub operatively connected to the at least one telemetry kit and the at least one downhole tool.

17. The wellbore communication system of claim 15, further comprising at least one additional drill pipe positionable between at least two of the at least one telemetry kits.

18. The wellbore communication system of claim 15, wherein a transmission element of the telemetry kit comprises a cable.

19. The wellbore communication system of claim 15, wherein a transmission element of the telemetry kit comprises a conductive drill pipe.

20. The wellbore communication system of claim 15, further comprising a telemetry adapter for operatively connecting the telemetry kit to the wired drill pipe telemetry system.

21. The wellbore communication system of claim 15, further comprising a surface sub operatively connected between the surface control unit and the wired drill pipe telemetry system.

22. The wellbore communication system of claim 21, wherein the telemetry kit is operatively connected to the surface control unit via the surface sub.

23. The wellbore communication system of claim 15, wherein the wired drill pipe telemetry system is one of wired, wireless and combinations thereof.

24. A method of communicating between a surface control unit and a downhole tool via a wired drill pipe telemetry system, the downhole tool deployed via a drill string into a wellbore penetrating a subsurface formation, comprising:
operatively connecting a first terminal of at least one telemetry kit to the wired drill pipe telemetry system for communication therewith;
operatively connecting a second terminal of the at least one telemetry kit to one of a downhole tool and a surface control unit for communication therewith; and
operatively connecting a transmission element between the first and second terminals such that the at least one telemetry kit traverses at least a portion of one of the downhole tool, the wired drill pipe telemetry system and combinations thereof; and
passing a signal between the surface control unit and the downhole tool via the wired drill pipe and the telemetry kit.

25. The method of claim 24, wherein a portion of one of the drill string, the downhole tool and combinations thereof are bypassed as signals are passed through the telemetry kit.
